(19) United States
(12) Patent Application Publication
(10) Pub. No.: US 2024/0151242 A1
(43) Pub. Date: May 9, 2024

(54) Liquid Cooling Pumping Unit

(71) Applicant: Cooler Master Co., Ltd., Taipei City (TW)

(72) Inventor: Tsung-Wei LIN, Taipei City (TW)

(21) Appl. No.: 18/501,991

(22) Filed: Nov. 4, 2023

(30) Foreign Application Priority Data
Nov. 7, 2022 (TW) 111212168

(51) Int. Cl. F04D 29/42; F04D 1/00

(52) U.S. Cl. CPC F04D 29/4293; F04D 1/00

(57) ABSTRACT

A liquid cooling pump unit including a pump unit and water block unit is provided. The pump unit includes a chamber body and rotor assembly unit. The rotor assembly unit is mounted to and in fluid communication with the chamber body. The pump unit is mounted to and in fluid communication with the water block unit. The chamber body includes a chamber bottom having a chamber side including a pair of velocity enhancing openings. The pair of velocity enhancing openings is configured so that the working fluid flows from the rotor assembly unit to the water block unit via the pair of velocity enhancing openings. The rotor assembly unit is configured to increase a pressure and flow of working fluid flowing through the water block unit. The pair of velocity enhancing openings is configured to increase a velocity of the flow of working fluid to the water block unit.

### RELATED APPLICATIONS

This US application claims the benefit of priority to Taiwan application no. 111212168, filed on Nov. 7, 2022, of which is incorporated herein by reference in its entirety.

### TECHNICAL FIELD

The present disclosure is related to the field of heat transfer in general and more particularly but not limited to liquid cooling pump units.

### BACKGROUND OF THE INVENTION

With the increase of the processing speed and performance of electronic components, such as central processing units (CPU), the amount of heat generated during operation of the electronic component increases. The heat generation increases the temperature of the electronic component and, if the heat cannot be dissipated effectively, reliability and performance of the electronic component are reduced. To prevent overheating of an electronic component, typically, a liquid cooling apparatus is used for cooling the electronic component and, thereby maintaining normal operation of the electronic component.

Existing liquid cooling apparatuses typically include a base plate of a heat exchange chamber attached to a CPU, and the heat exchange chamber is fluidly connected to a fluid circulating pump. The pump circulates the fluid inside the heat exchange chamber in order to deliver the fluid at lower temperature to the heat exchange chamber. As the fluid circulates in the heat exchange chamber, thermal energy is exchanged between the base plate and the fluid and, as a result, the temperature of the base plate is reduced and the temperature of the fluid increases. However, fluid communication between the existing pumps and the existing heat exchange chambers are often of complicated structures and this causes a reduction in the heat transfer efficiency. Also, maintenance, repair, parts replacement, and versatility of existing fluid cooling apparatuses is inconvenient and inefficient.

### SUMMARY OF THE INVENTION

The present disclosure provides a liquid cooling pump unit including a pump unit and a water block unit. Turbulence of a flow of working fluid to a rotary assembly unit of the pump unit is decreased via a spacing disc. Velocity of the flow of working fluid to the water block unit is increased via a pair of velocity enhancing openings. The rotary assembly unit is a module, making maintenance, repair, parts replacement, and versatility more convenient and efficient, and allowing for mounting to and fluid communication with different dimension water block units.

In at least one embodiment, the liquid cooling pump unit includes a pump unit and a water block unit. The water block unit includes a water block set and a flow plate. The flow plate is assembled to and in fluid communication with the water block set. The pump unit includes a chamber body and a rotor assembly unit. The rotor assembly unit is mounted to and in fluid communication with the chamber body. The pump unit is mounted to and in fluid communication with the water block unit. The rotor assembly unit is configured to increase a pressure and a flow of a working fluid flowing through the water block unit. The chamber body includes a chamber bottom, a liquid flow wall section, an opposing wall section, and a pair of side wall sections. The chamber bottom includes a chamber side and a block cover side. The block cover side is opposite the chamber side. The flow plate is between the block cover side and the water block set. Each of the pair of side wall sections is between the liquid flow wall section and the opposing wall section on opposite edges of the liquid flow wall section and the opposing wall section, respectively. The liquid flow wall section, the opposing wall section, and the pair of side wall sections extend vertically from the chamber side. The liquid flow wall section includes an inlet port and an outlet port. The inlet port is configured for a working fluid to flow to the chamber body and the outlet port is configured for the working fluid to flow out of the chamber body. The chamber side includes a pair of velocity enhancing openings. The pair of velocity enhancing openings is configured so that the working fluid flows from the rotor assembly unit to the water block unit via the pair of velocity enhancing openings and the flow plate. The pair of velocity enhancing openings is also configured to increase a velocity of the flow of working fluid to the water block unit.

In at least one embodiment, each of the pair of velocity enhancing openings is disposed adjacent to each of the pair of side wall sections, respectively. In at least one embodiment, the flow plate includes a through slit and an outlet cutout, the through slit is longitudinally disposed centrally through the flow plate and the outlet cutout is cutout from a corner of the flow plate. Each of the pair of velocity enhancing openings, respectively, begins fluid communication with the through slit via opposite longitudinal ends of the through slit such that the working fluid flows thorough the through slit from opposite longitudinal ends of the through slit to a center of the through slit, increasing turbulence, and further increasing the velocity of the flow of working fluid to the water block unit.

In at least one embodiment, the block cover side includes a longitudinal indentation and a block outlet through hole. The longitudinal indentation has two opposite ends. The longitudinal indention is disposed centrally within the block cover side. Each of the two opposite ends is opposite each of the pair of velocity enhancing openings, respectively. A distance between each of the two opposite ends is greater than a length of the through slit. The block outlet through hole is disposed through the chamber bottom between one of the two opposite ends and the outlet port.

In at least one embodiment, the water block set includes a water block base and a fin plate. The water block base includes a base cavity having heat transfer surface features thereon. The fin plate includes a fin through slit longitudinally disposed centrally through the fin plate. The fin through slit is positioned longitudinally on and in fluid communication with the heat transfer surface features. The fin through slit corresponds to and is in fluid communication with the through slit. The water block set is configured to be in direct or indirect contact with a heat source opposite the base cavity.

In at least one embodiment, the rotor assembly unit includes a rotor housing, a stator assembly, an impeller, and a multi-functional flow plate. The rotor housing has a perimeter cover, a stator cavity and an impeller annular cavity. The perimeter cover surrounds the stator cavity and impeller annular cavity. The impeller annular cavity is opposite the stator cavity. The stator assembly is assembled in the stator cavity. The impeller is assembled in the impeller annular cavity. The impeller has a plurality of curved blades and a shaft. The plurality of curved blades is configured to rotate in the impeller annular cavity. The shaft is opposite the plurality of curved blades. The stator assembly is configured to drive the impeller. The multi-functional flow plate has a pair of impeller inlet openings and a pair of impeller outlet openings. The pair of impeller inlet openings is centrally disposed through the multi-functional flow plate. The pair of impeller outlet openings is disposed through opposite sections of the multi-functional flow plate. The pair of impeller inlet openings is between the pair of impeller outlet openings. The multi-functional flow plate is mounted to and covers the impeller annular cavity. The pair of impeller outlet openings is mounted to and in fluid communication with the pair of velocity enhancing openings. The perimeter cover is mounted to and covers the chamber body. In at least one embodiment, a distance between each of the pair of impeller outlet openings is greater than a diameter of the impeller.

In at least one embodiment, the rotor assembly unit further includes a spacing disc. The spacing disc is assembled between the impeller annular cavity and the multi-functional flow plate. The spacing disc is configured to increase a distance of the flow of working fluid flowing from the chamber body to the rotor assembly unit, decreasing turbulence of the flow of working fluid to the rotor assembly unit.

In at least one embodiment, the chamber body further includes a partition. The partition is disposed vertically on the chamber side between the inlet port and the outlet port and between each of the pair of velocity enhancing openings. The partition partially defines an inlet sub-chamber and partially defines an outlet sub-chamber. The inlet sub-chamber is in fluid communication with the inlet port and the rotor assembly unit. The outlet sub-chamber is in fluid communication with the water block unit and the outlet port.

### BRIEF DESCRIPTION OF DRAWINGS

Unless specified otherwise, the accompanying drawings illustrate aspects of the innovative subject matter described herein. Referring to the drawings, wherein like reference numerals indicate similar parts throughout the several views, several examples of liquid cooling pump units incorporating aspects of the presently disclosed principles are illustrated by way of example, and not by way of limitation.

FIG. 1A is a perspective view of a liquid cooling pump unit according to one embodiment of the present disclosure.

FIG. 16 is an exploded view of the liquid cooling pump unit of FIG. 1 according to one embodiment of the present disclosure.

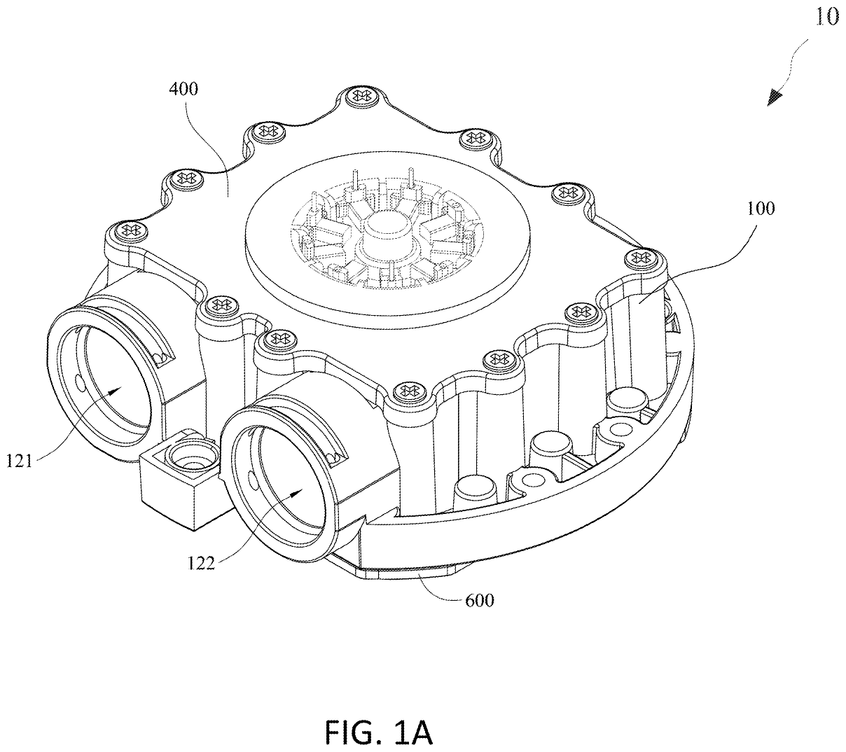

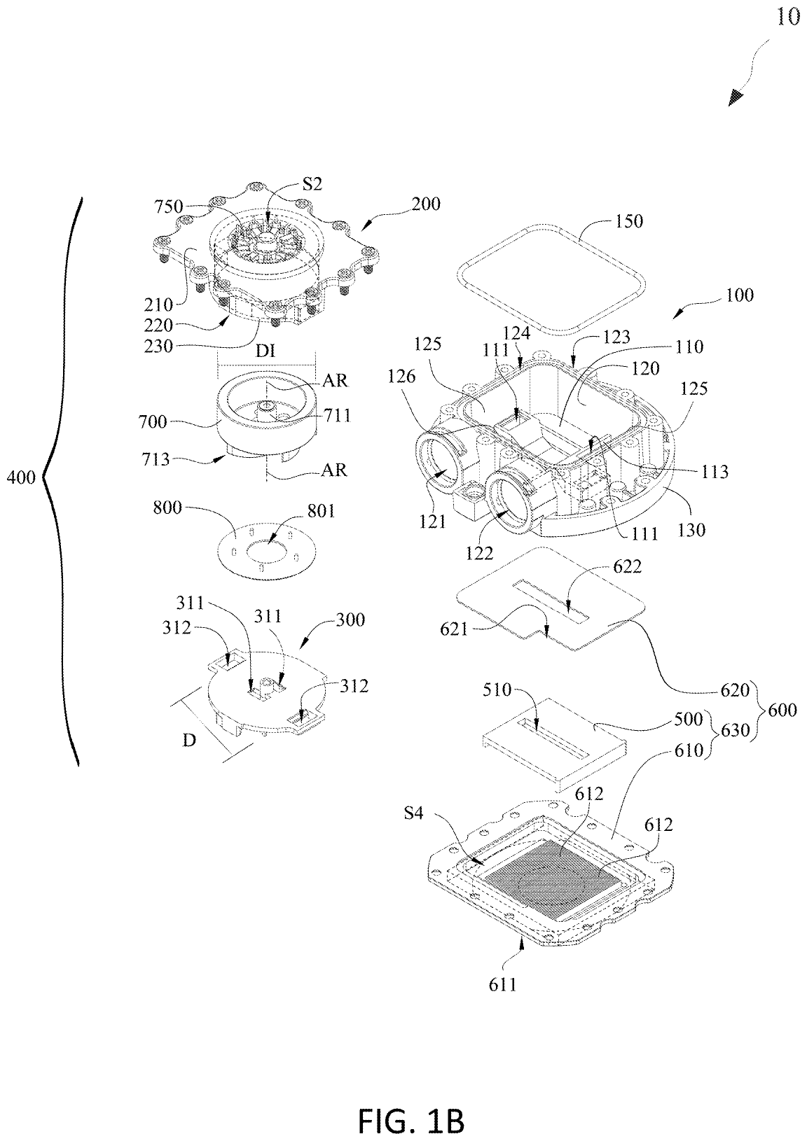

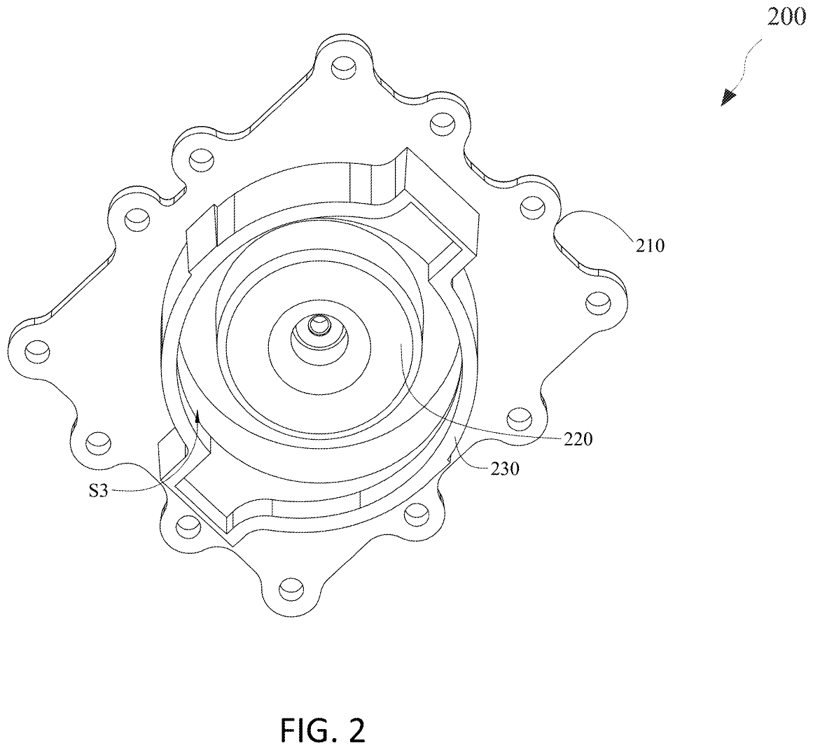

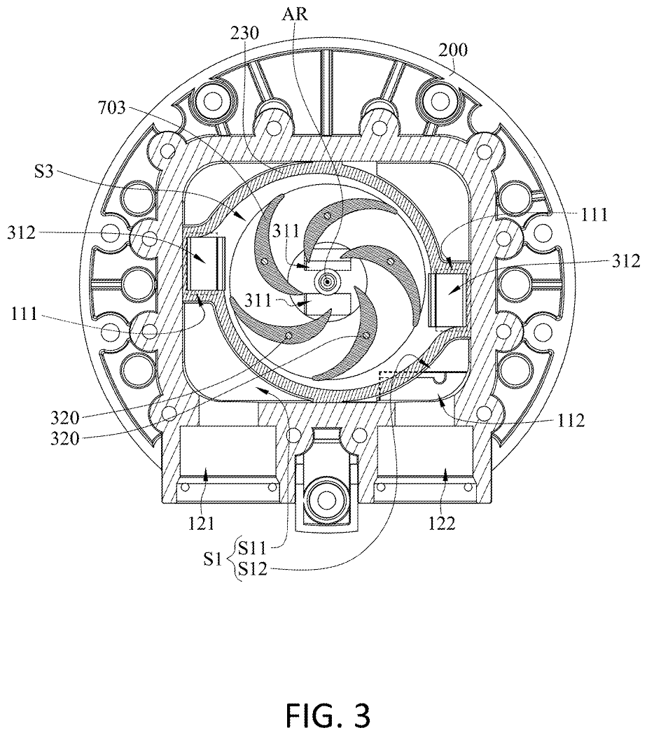

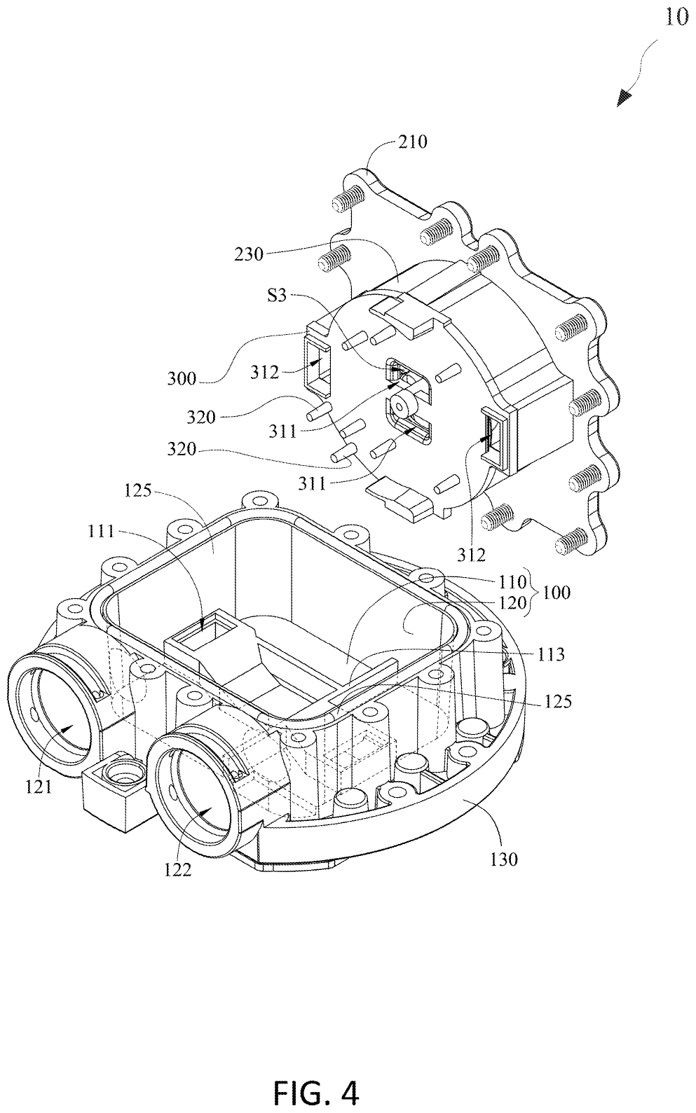

FIG. 2 is a perspective of a rotor housing of the liquid cooling pump unit of FIGS. 1A and 1B according to one embodiment of the present disclosure.

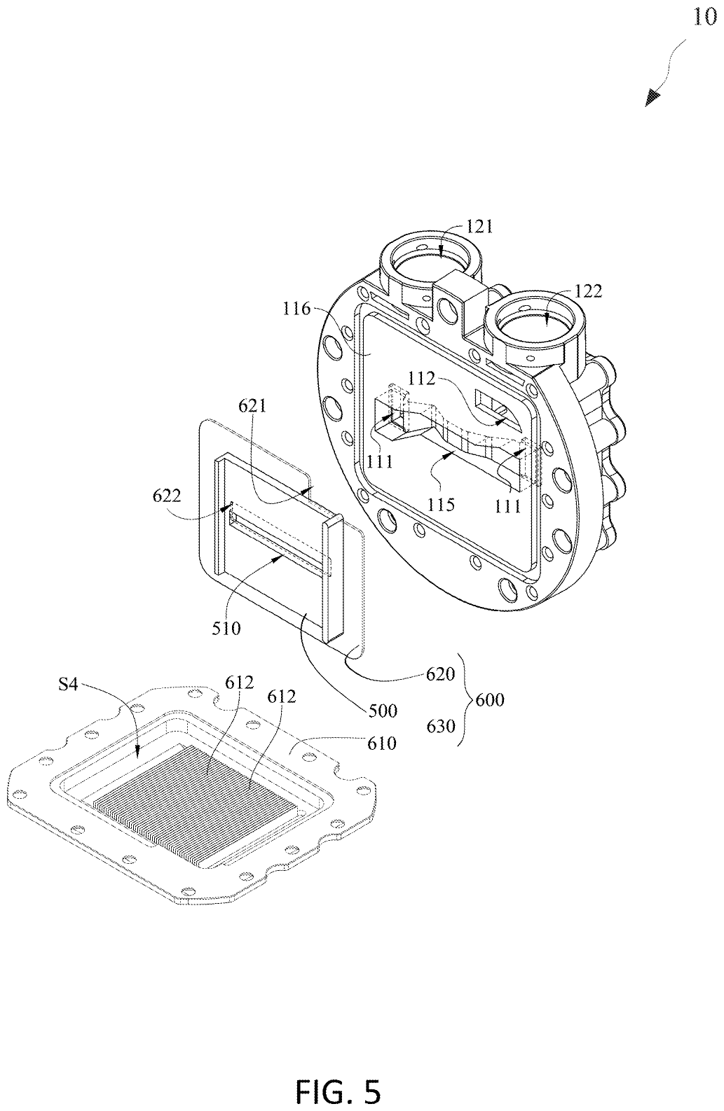

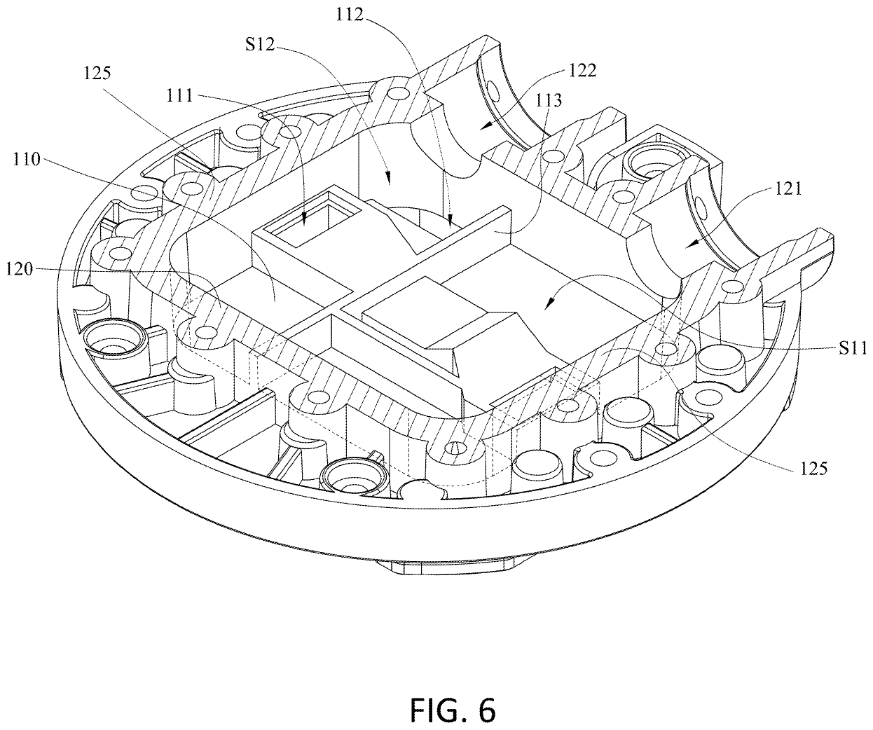

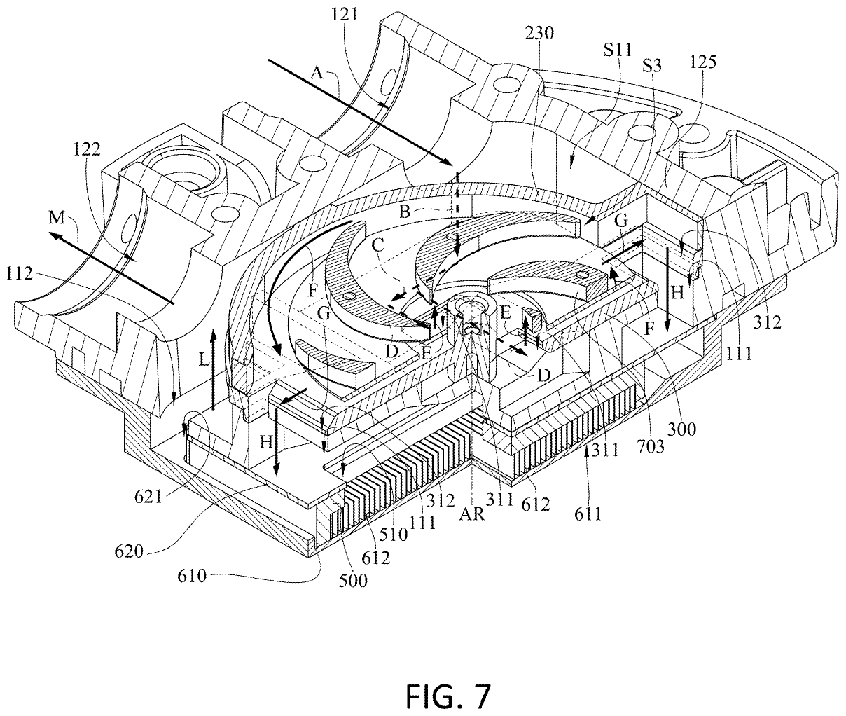

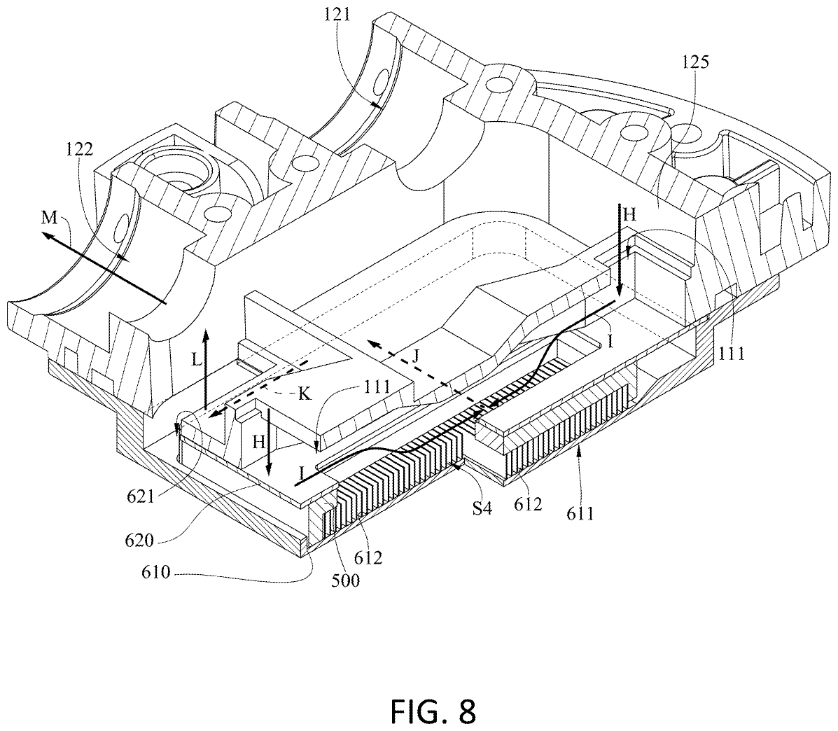

FIG. 3 is a cross-sectional view of a rotor assembly unit of the liquid cooling pump unit of FIGS. 1A and 16 according to one embodiment of the present disclosure.

FIG. 4 is a perspective view a rotor assembly unit and a chamber body mounted to a water block unit of the liquid cooling pump unit of FIGS. 1A and 18 according to one embodiment of the present disclosure.

FIG. 5 is a perspective view a water block unit and a rotary assembly unit of the liquid cooling pump unit of FIGS. 1A and 18 according to one embodiment of the present disclosure.

FIG. 6 is a cross-sectional view of a chamber body of the liquid cooling pump unit of FIGS. 1A and 18 according to one embodiment of the present disclosure.

FIG. 7 is cross-sectional views illustrating a flow of working fluid through the liquid cooling pump unit of FIGS. 1A and 18 according to one embodiment of the present disclosure.

FIG. 8 is cross-sectional views illustrating the flow of working fluid from the pump unit through the water block unit of FIGS. 1A and 18 according to one embodiment of the present disclosure.

### DETAILED DESCRIPTION

The following describes various principles related to thermal control of electronic components by way of reference to specific examples of liquid cooling pump units, including specific arrangements and examples of pump units and water block units embodying innovative concepts. More particularly, but not exclusively, such innovative principles are described in relation to selected examples of a spacing disc and how the spacing disc decreases turbulence of a flow of working fluid to a rotor assembly unit, and a pair of velocity enhancing openings and how the pair of velocity enhancing openings increase a velocity of the flow of working fluid to the water block unit, and well-known functions or constructions are not described in detail for purposes of succinctness and clarity. Nonetheless, one or more of the disclosed principles can be incorporated in various other embodiments of spacing discs and pairs of velocity enhancing openings to achieve any of a variety of desired outcomes, characteristics, and/or performance criteria.

Thus, liquid cooling pump units having attributes that are different from those specific examples discussed herein can embody one or more of the innovative principles, and can be used in applications not described herein in detail. Accordingly, embodiments of liquid cooling pump units not described herein in detail also fall within the scope of this disclosure, as will be appreciated by those of ordinary skill in the relevant art following a review of this disclosure.

Example embodiments as disclosed herein are directed to liquid cooling systems, wherein a water block unit is in thermal contact with electric and/or electronic components, devices and/or systems, transporting heat away therefrom, and then cooling fluid, circulating inside of a cooling loop system incorporating the water block unit, flows over the water block unit by a pump unit, removing heat therefrom. The heated cooling fluid is output from the water block unit and may be input to a radiator. The heated cooling fluid may flow to and through the radiator, whereby, the radiator may have a plurality of heat fins thereon for increased heat dissipation. Then the cooling fluid may flow from the radiator to the pump unit and the water block to once again begin the cooling loop.

The liquid cooling system may be configured within a chassis or as part of an electric or electronics system that includes heat producing electronic components to be cooled. The liquid cooling system includes at least one liquid-based cooling loop, and may further comprise one or more fans. The one or more fans may be coupled to the back end of a radiator via a fastener (e.g., bolts, screws, an adhesive material, etc.) at structural portions of the radiator, transporting air through the radiator to an air plenum or to an outside of the chassis or electric or electronics system.

FIGS. 1A and 16 include at least one embodiment of a liquid cooling pumping unit 10. The liquid cooling pumping unit 10 includes a pump unit 400, 100 and a water block unit 600, and can be substantially square shaped. The water block unit 600 includes a water block set 630 and a flow plate 620. The flow plate 620 is assembled to and in fluid communication with the water block set 630. The water block set 630 can be substantially square shaped and the flow plate 620 can be substantially rectangular shaped. The pump unit 400, 100 includes a chamber body 100 and a rotor assembly unit 400. The rotor assembly unit 400 is mounted to and in fluid communication with the chamber body 100. The pump unit 400, 100 is mounted to and in fluid communication with the water block unit 600. The rotor assembly unit 400 is configured to increase a pressure and a flow of a working fluid flowing through the water block unit 600. The chamber body 100 includes a chamber bottom 130, a liquid flow wall section 126, an opposing wall section 120, and a pair of side wall sections 125. The chamber bottom 130 includes a chamber side 110 and a block cover side 116, and can be substantially circular shaped. The block cover side 116 is opposite the chamber side 110. The flow plate 620 is between the block cover side 116 and the water block set 630. Each of the pair of side wall sections 125 is between the liquid flow wall section 126 and the opposing wall section 120 on opposite edges of the liquid flow wall section 126 and the opposing wall section 120, respectively. The liquid flow wall section 126, the opposing wall section 120, and the pair of side wall sections 125 extend vertically from the chamber side 110, and can form a substantially square chamber. The liquid flow wall section 126 includes an inlet port 121 and an outlet port 122. The inlet port 121 is configured for a working fluid to flow to the chamber body 100 and the outlet port 122 is configured for the working fluid to flow out of the chamber body 100. The inlet port 121 and the outlet port 122 can be substantially cylindrical shaped. The chamber side 110 includes a pair of velocity enhancing openings 111. The pair of velocity enhancing openings 111 can be rectangular shaped. The pair of velocity enhancing openings 111 is configured so that the working fluid flows from the rotor assembly unit 400 to the water block unit 600 via the pair of velocity enhancing openings 111 and the flow plate 620. The pair of velocity enhancing openings 111 is also configured to increase a velocity of the flow of working fluid to the water block unit 600. In at least one embodiment, the pair of velocity enhancing openings 111 can protrude from the chamber side 110 in a direction that is opposite the block cover side 116.

In at least one embodiment, the liquid cooling pumping unit 10 further includes a plurality of gaskets 150 and the chamber body 100 further includes a gasket groove 124. The gasket groove 124 is disposed on edges 123 of the liquid flow wall section 126, the opposing wall section 120, and the pair of side wall sections 125, opposite the chamber side 110, wherein at least one of the plurality of gaskets 150 is assembled within the gasket groove 124 so that the rotor assembly unit 400 is tightly mounted to the chamber body 100.

In at least one embodiment, the liquid cooling pumping unit 10 further includes a cover (not shown). The cover can be substantially square shaped and be configured to cover the rotor assembly unit 400 up to the chamber bottom 130 of the chamber body 100 of the pump unit 400. The cover can be mounted to the chamber bottom 130 and include cutouts for the inlet port 121 and outlet port 122.

FIG. 2 includes at least one embodiment of a rotor housing 200 and FIG. 3 includes at least one embodiment of a rotor assembly unit 400. The rotor assembly unit 400 includes a rotor housing 200, a stator assembly 750, an impeller 700, and a multi-functional flow plate 300. The rotor housing 200 includes a perimeter cover 210, a stator cavity S2 and an impeller annular cavity S3. The perimeter cover 210 surrounds the stator cavity S2 and the impeller annular cavity S3. The perimeter cover 210 can be substantially square shaped and the stator cavity S2 and the impeller annular cavity S3 can be substantially cylindrical shaped, respectively. The impeller annular cavity S3 is opposite the stator cavity S2. The perimeter cover 210 surrounds an opening side of the stator cavity S2 and a bottom side of the impeller annular cavity S3. Dimensions of the stator assembly 750 correspond to dimensions of the stator cavity S2, and the stator assembly 750 is assembled in the stator cavity S2. Dimensions of the impeller 700 correspond to dimensions of the impeller annular cavity S3, and the impeller 700 is assembled in the impeller annular cavity S3. The impeller 700 has a plurality of curved blades 713 and a shaft 711. The plurality of curved blades 713 is configured to rotate AR in the impeller annular cavity S3. The shaft 711 is opposite the plurality of curved blades 713. The stator assembly 750 is configured to drive the impeller 700. The multi-functional flow plate 300 has a pair of impeller 700 inlet openings 311 and a pair of impeller 700 outlet openings 312. The multi-functional flow plate 300 can be substantially circular shaped. The pair of impeller 700 inlet openings 311 is centrally disposed through the multi-functional flow plate 300. The pair of impeller 700 inlet openings 311 can be substantially rectangular shaped. The pair of impeller 700 outlet openings 312 is disposed through opposite sections of the multi-functional flow plate 300. The pair of impeller 700 outlet openings 312 can be substantially rectangular shaped. The pair of impeller 700 inlet openings 311 is between the pair of impeller 700 outlet openings 312. The multi-functional flow plate 300 is mounted to and covers the impeller annular cavity S3. The pair of impeller 700 outlet openings 312 is mounted to and in fluid communication with the pair of velocity enhancing openings 111. The perimeter cover 210 is mounted to and covers the chamber body 100. In at least one embodiment, a distance D between each of the pair of impeller 700 outlet openings 312 is greater than a diameter DI of the impeller 700. The multi-functional flow plate 300 further includes a plurality of support posts 320. The plurality of support posts 320 can be substantially cylindrical shaped and is configured to support the multi-functional flow plate 300 when mounted to and in fluid communication with the pair of velocity enhancing openings 111.

In at least one embodiment, the rotor housing 200 further includes a cavity wall 230 and a torus-like structure 220. The cavity wall 230 can be substantially cylindrical shaped and the torus-like structure 220 can be torus-like shaped. The annular cavity wall 230 surrounds the torus-like structure 220A and a cavity between the annular cavity wall 230 and the torus-like structure 220A defines the impeller annular cavity S3.

In at least one embodiment, the rotor assembly unit 400 further includes a spacing disc 800. The spacing disc 800 can be substantially disk shaped, is assembled between the impeller annular cavity S3 and the multi-functional flow plate 300 and includes a central opening 801. The central opening 801 can be substantially circular shaped and a diameter of the central opening 801 is greater than a distance between each of the pair of impeller inlet openings 311. The spacing disc 800 is configured to increase a distance of the flow of working fluid flowing from the chamber body 100 to the rotor assembly unit 400, decreasing turbulence of the flow of working fluid to the rotor assembly unit 400.

In at least one embodiment, the rotor assembly unit 400 further includes a motor control circuit (not shown). The motor control circuit can be disposed on the rotor housing 200 and can be electrically connected to the stator assembly 750.

FIG. 4 includes a rotor assembly unit 400 and a chamber body 100 mounted to a water block unit 600 of the liquid cooling pumping unit 10. The flow plate 620 includes a through slit 622 and an outlet cutout 621. The through slit 622 is longitudinally disposed centrally through the flow plate 620 and the outlet cutout 621 is cutout from a corner of the flow plate 620. The flow plate 620 can be substantially rectangular shaped, the through slit 622 can be substantially rectangular slit shaped and an outlet cutout 621 can be a substantially rectangular cutout. Each of the pair of velocity enhancing openings 111 is disposed adjacent to each of the pair of side wall sections 125, respectively. Each of the pair of velocity enhancing openings 111, respectively, begins fluid communication with the through slit 622 via opposite longitudinal ends of the through slit 622 such that the working fluid flows thorough the through slit 622 from opposite longitudinal ends of the through slit 622 to a center of the through slit 622, increasing turbulence, and further increasing the velocity of the flow of working fluid to the water block unit 600. In at least one embodiment, the pair of velocity enhancing openings 111 is offset on opposite sides of the longitudinal ends of the through slit 622, respectively, yet further increasing turbulence, and yet further increasing the velocity of the flow of working fluid to the water block unit 600.

FIG. 5 includes a water block unit 600 and a rotary assembly unit of the liquid cooling pumping unit 10. The block cover side 116 includes a longitudinal indentation 115 and a block outlet through hole 112. The longitudinal indentation 115 has two opposite ends. The longitudinal indention is disposed centrally within the block cover side 116. Each of the two opposite ends is opposite each of the pair of velocity enhancing openings 111, respectively. Each of the two opposite ends corresponds to the protrusion of the pair of velocity enhancing openings 111 from the chamber side 110. A distance between each of the two opposite ends is greater than a length of the through slit 622. The block outlet through hole 112 is disposed through the chamber bottom 130 between one of the two opposite ends and the outlet port 122.

The water block set 630 includes a water block base 610 and a fin plate 500. The water block base 610 includes a base cavity S4 having heat transfer surface features 612 thereon and a base contact surface 611. The water block base 610 can be substantially square shaped and the fin plate 500 can be substantially rectangular shaped. The fin plate 500 includes a fin through slit 510 longitudinally disposed centrally through the fin plate 500. The fin through slit 510 can be substantially rectangular slit shaped and is positioned longitudinally on and in fluid communication with the heat transfer surface features 612. The fin through slit 510 corresponds to and is in fluid communication with the through slit 622. A size of the fin through slit 510 is smaller than a size of the through slit 622. The water block set 630 is configured to be in direct or indirect contact with a heat source, such as a CPU or graphics processor unit (GPU), as an example, opposite the base cavity S4 via the base contact surface 611. In at least one embodiment, the fin plate 500 is integrally formed with the flow plate 620. In at least one embodiment, a size or shape of the fin through slit 510 and a size or shape of the through slit 622 can be adjusted to accommodate a size and/or disposition of the heat source, assuring heat transfer efficiency within the water block unit 600, whereby the adjusted size of the fin through slit is smaller than the adjusted size of the through slit.

FIG. 6 includes a chamber body 100 of the liquid cooling pumping unit 10. The chamber body 100 further includes a partition 113. The partition 113 can be substantially rectangular shaped and is disposed vertically on the chamber side 110 between the inlet port 121 and the outlet port 122 and between each of the pair of velocity enhancing openings 111. The partition 113 partially defines an inlet sub-chamber S11 and partially defines an outlet sub-chamber S12. The inlet sub-chamber S11 is in fluid communication with the inlet port 121 and the rotor assembly unit 400. The outlet sub-chamber S12 is in fluid communication with the water block unit 600 and the outlet port 122.

FIGS. 7-8 are cross-sectional views of a flow implementation of the liquid cooling pumping unit 10. In operation, a working fluid is provided to the inlet sub-chamber S11 via the inlet port 121. The working fluid flows through the inlet port 121 and inlet sub-chamber S11 to the pair of impeller outlet openings 312 (flows A, B, C, and D). The working fluid then flows to the plurality of curved blades 713 of the impeller 700 via the pair of impeller outlet openings 312 and central opening 801 of the spacing disc 800 (flow E). The spacing disc 800 increases a distance of the flow of working fluid from the inlet sub-chamber S11 to the plurality of curved blades 713, decreasing turbulence of the flow of working fluid at the plurality of curved blades 713. The working fluid then flows through the plurality of curved blades 713 to the heat transfer surface features 612 of the base cavity S4 via the pair of impeller outlet openings 312, the pair of velocity enhancing openings 111, the through slit 622, and the fin through slit 510 (flows F, G, H, and I). The rotating plurality of curved blades 713 increase a pressure and the flow of working fluid flowing to and through the water block unit 600. The pair of velocity enhancing openings 111 produce two separate flow origins of working fluid to the heat transfer surface features 612, increasing turbulence, and thus, increasing velocity of the flow of working fluid to the base cavity S4. When the working fluid is passed through the base cavity S4, heat is drawn from electrical or electronic components (heat producing components) of a system that a liquid cooling system cools (flows J and K). The working fluid then passes through the outlet cutout 621 and then out through the outlet port 122 where it is cooled to release heat, effectively cooling the heat producing components (flows L and M). The working fluid is continuously pumped, as well as continuously cooled, so that continuous cooling of the heat producing components can be achieved.

The liquid cooling pumping units 10 of the present disclosure decrease turbulence of the flow of working fluid to the rotor assembly unit 400 and increase velocity of the flow of working fluid to the water block unit 600. The spacing disc 800 between the impeller annular cavity S3 and the multi-functional flow plate 300 of the rotary assembly unit, increases a distance of the flow of working fluid flowing from the chamber body 100 to the rotor assembly unit 400. Thus, as the distance is increased, turbulence of the flow of working fluid to the rotor assembly unit 400 is decreased, increasing efficiency of the rotary assembly unit. The velocity of the flow of working fluid to the water block unit 600 is increased by having two openings (pair of velocity enhancing openings 111) into the water block unit 600 from the pump unit 400, 100 as opposed to just one opening. The two openings, whereby two flows of working fluid flow into the water block unit 600, increase turbulence within the water block unit 600. As a result, with increased turbulence, the velocity of the flow of working fluid to the water block unit 600 is increased, increasing heat transfer efficiency within the water block unit 600. Moreover, each of the pair of velocity enhancing openings 111 begins fluid communication with the through slit 622 via opposite longitudinal ends of the through slit 622. Thus, working fluid flows thorough the through slit 622 from opposite longitudinal ends of the through slit 622 to a center of the through slit 622, further assuring increased turbulence, and further assuring increased velocity of the flow of working fluid to the water block unit 600. Furthermore, with the rotary assembly unit being a module, and fluid communication between the rotary assembly unit and water block unit 600 simplified via mounting to the pair of velocity enhancing openings 111, maintenance, repair, parts replacement, and versatility of the rotary assembly unit, chamber body 100 and water block unit 600 is made more convenient and efficient. Also, the rotary assembly unit can be mounted to and in fluid communication with different dimension water block unit 600s, as an example, dimensions of the chamber bottom 130 and water block unit 600 is increased, with a same specification for mounting to the pair of velocity enhancing openings 111 by the rotary assembly unit.

Therefore, embodiments disclosed herein are well adapted to attain the ends and advantages mentioned as well as those that are inherent therein. The particular embodiments disclosed above are illustrative only, as the embodiments disclosed may be modified and practiced in different but equivalent manners apparent to those of ordinary skill in the relevant art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some number. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A liquid cooling pump unit, comprising:
a water block unit comprising,
a water block set, and
a flow plate, assembled to and in fluid communication with the water block set, and
a pump unit comprising,
a chamber body, mounted to and in fluid communication with the water block unit, the chamber body comprising a chamber bottom having a chamber side comprising a pair of velocity enhancing openings and a block cover side opposite the chamber side, a liquid flow wall section having an inlet port and an outlet port, an opposing wall section, and a pair of side wall sections, each of the pair of side wall sections is between the liquid flow wall section and the opposing wall section on opposite edges of the liquid flow wall section and the opposing wall section, respectively, the liquid flow wall section, the opposing wall section, and the pair of side wall sections extend vertically from the chamber side, and
a rotor assembly unit, mounted to and in fluid communication with the chamber body,
wherein the block cover side is mounted to the water block set and the flow plate is between the chamber body and water block set,
wherein the inlet port is configured for a working fluid to flow to the chamber body and the outlet port is configured for the working fluid to flow out of the chamber body,
wherein the rotor assembly unit is configured to increase a pressure and a flow of the working fluid flowing through the water block unit, AND
wherein the pair of velocity enhancing openings is configured so that the working fluid flows from the rotor assembly unit to the water block unit via the pair of velocity enhancing openings and the flow plate, and the pair of velocity enhancing openings is also configured to increase a velocity of the flow of working fluid to the water block unit.

2. The liquid cooling pump unit of claim 1, wherein each of the pair of velocity enhancing openings is disposed adjacent to each of the pair of side wall sections, respectively.

3. The liquid cooling pump unit of claim 2, wherein the flow plate comprises a through slit and an outlet cutout, the through slit longitudinally disposed centrally through the flow plate, the outlet cutout cutout from a corner of the flow plate, and wherein each of the pair of velocity enhancing openings, respectively, begins fluid communication with the through slit via opposite longitudinal ends of the through slit such that the working fluid flows thorough the through slit from opposite longitudinal ends of the through slit to a center of the through slit, increasing turbulence, and further increasing the velocity of the flow of working fluid to the water block unit.

4. The liquid cooling pump unit of claim 3, wherein the block cover side comprises a longitudinal indentation and a block outlet through hole, the longitudinal indentation having two opposite ends, the longitudinal indention disposed centrally within the block cover side, each of the two opposite ends opposite each of the pair of velocity enhancing openings, respectively, a distance between each of the two opposite ends is greater than a length of the through slit, the block outlet through hole disposed through the chamber bottom between one of the two opposite ends and the outlet port.

5. The liquid cooling pump unit of claim 3, wherein the water block set comprises a water block base and a fin plate, the water block base having a base cavity, the base cavity comprising heat transfer surface features thereon, the fin plate comprising a fin through slit longitudinally disposed centrally through the fin plate, the fin through slit positioned longitudinally on and in fluid communication with the heat transfer surface features, the fin through slit corresponding to and in fluid communication with the through slit, and wherein the water block set is configured to be in direct or indirect contact with a heat source opposite the base cavity.

6. The liquid cooling pump unit of claim 1, wherein the rotor assembly unit comprises a rotor housing, a stator assembly, an impeller, and a multi-functional flow plate, the impeller having a plurality of curved blades and a shaft, the shaft opposite the plurality of curved blades, the rotor housing having a perimeter cover, a stator cavity and an impeller annular cavity, the perimeter cover surrounding the stator cavity and impeller annular cavity, the impeller annular cavity opposite the stator cavity, the multi-functional flow plate having a pair of impeller inlet openings and a pair of impeller outlet openings, the pair of impeller inlet openings centrally disposed through the multi-functional flow plate, the pair of impeller outlet openings disposed through opposite sections of the multi-functional flow plate, the pair of impeller inlet openings between the pair of impeller outlet openings, the stator assembly assembled in the stator cavity, the impeller assembled in the impeller annular cavity, the multi-functional flow plate mounted to and covering the impeller annular cavity, the perimeter cover mounted to and covering the chamber body, the pair of impeller outlet openings mounted to and in fluid communication with the pair of velocity enhancing openings, the stator assembly configured to drive the impeller, the plurality of curved blades configured to rotate in the impeller annular cavity.

7. The liquid cooling pump unit of claim 6, wherein a distance between each of the pair of impeller outlet openings is greater than a diameter of the impeller.

8. The liquid cooling pump unit of claim 6, wherein the rotor assembly unit further comprises a spacing disc, the spacing disc assembled between the impeller annular cavity and the multi-functional flow plate, the spacing disc configured to increase a distance of the flow of working fluid flowing from the chamber body to the rotor assembly unit, decreasing turbulence of the flow of working fluid to the rotor assembly unit.

9. The liquid cooling pump unit of claim 1, wherein the chamber body further comprises a partition, the partition disposed vertically on the chamber side between the inlet port and the outlet port and between each of the pair of velocity enhancing openings, the partition partially defining an inlet sub-chamber and partially defining an outlet sub-chamber, the inlet sub-chamber in fluid communication with the inlet port and the rotor assembly unit, the outlet sub-chamber in fluid communication with the water block unit and the outlet port.
